(19) United States
(12) Patent Application Publication
(10) Pub. No.: US 2015/0084729 A1
(43) Pub. Date: Mar. 26, 2015

(54) MULTILAYER TYPE INDUCTOR

(71) Applicant: Samsung Electro-Mechanics Co., Ltd., Suwon-si (KR)

(72) Inventor: Heoung Sub LEE, Busan (KR)

(21) Appl. No.: 14/495,360

(22) Filed: Sep. 24, 2014

(30) Foreign Application Priority Data
Sep. 24, 2013 (KR) 10-2013-0113336

(51) Int. Cl. H01F 27/28; H01F 27/29

(52) U.S. Cl. CPC H01F 27/2804; H01F 27/29; H01F 2027/2809
USPC 336/192

(57) ABSTRACT

Disclosed herein is a multilayer type inductor, including: a ceramic body formed by multilayering a plurality of ceramic sheets; internal electrodes multilayered, having the ceramic sheet disposed therebetween; a dummy pattern disposed on any one of upper and lower surfaces of the ceramic body; and external terminals disposed at both ends of the ceramic body, whereby an inductance value is finely controlled.

This application claims the foreign priority benefit under 35 U.S.C. Section 119 of Korean Patent Application Serial No. 10-2013-0113336 entitled “Multilayer Type Inductor” filed on Sep. 24, 2013, which is hereby incorporated by reference in its entirety into this application.

### BACKGROUND OF THE INVENTION

1. Technical Field

The present invention relates to a multilayer type inductor, and more particularly, to a multilayer type inductor capable of finely controlling inductance.

2. Description of the Related Art

An inductor element, which is one of the passive elements forming an electronic circuit, along with a resistor and a capacitor, has been mainly used in a power supply circuit, such as a DC-DC converter within electronic devices and has been widely used as a component which removes noise or forms an LC resonance circuit.

Meanwhile, with the development of IT technologies, miniaturization and thinness of electronic devices have been accelerated and thus a market demand for a small, thin element has been increased. Depending on the demand, the inductor element having a thin film structure has been proposed.

As one of the inductor elements having a thin film structure, a multilayer type inductor manufactured by multilayering a number of ceramic sheets including internal electrodes having a coil pattern plated on one surface thereof has been widely used. In the multilayer type inductor, the internal electrodes are connected to external terminals disposed at both ends of the ceramic sheet laminate to receive external power (Korean Patent Laid-Open Publication No. 10-2008-0106123).

In the multilayer type inductor, inductance values are determined by a material forming the inductor, that is, characteristics (permeability), an internal area of a coil formed by an inter-layer connection of the internal electrodes, the number of layers of the multilayered internal electrodes, and the like. Recently, a size of the inductor element is gradually reduced with the miniaturization of a product, such that it is difficult to accurately match the required inductance values.

As a general method of controlling the inductance values in the multilayer type inductor, there is a method of implementing desired inductance values by changing a composition of a ferrite material forming the ceramic sheet; however, in the case of the ferrite, the method has a constant permeability in a low frequency domain in which a frequency is reduced but suddenly reduces the permeability in a high frequency domain in which a frequency is increased. Therefore, due to the unstable permeability of the ferrite, it is not suitable to control the inductance by the method in the inductor element to be operated in the high frequency band.

Therefore, there is a need to control the inductance values by controlling the number of layers of the multilayered internal electrodes or the internal area of the coil in the multilayer type inductor for high frequency. Herein, referring to FIG. 7 illustrating a rate of change in the inductance values depending on the number of layers of the multilayered internal electrodes, the range of fluctuation in the inductance values is gradually increased as the number of layers of the multilayered internal electrodes is increased, such that it is difficult to finely control the inductance in a multilayer inductor element of, for example, five layers or more.

Meanwhile, Patent Document (Korean Patent Laid-Open Publication No. 10-1999-0000614) discloses the multilayer type inductor which may implement the desired inductance values by changing shapes of the internal electrodes (that is, changing the internal area of the coil).

In this case, however, it is expected that the shapes of the internal electrodes of all the number of layers are changed and thus the width of change in the inductance is large. Further, when the required inductance value is several, the shapes of the internal electrodes are individually changed depending on each of the inductance values, such that the reduction in process yield and the increase in production cost may be inevitable.

### RELATED ART DOCUMENT

### Patent Document

(Patent Document 1) Patent Document 1: Korean Patent Laid-Open Publication No. 10-2008-0106123

(Patent Document 2) Patent Document 2: Korean Patent Laid-Open Publication No. 10-1999-0000614

### SUMMARY OF THE INVENTION

An object of the present invention is to provide a multilayer type inductor including a part for preventing a magnetic flux from flowing to more finely control inductance values, thereby controlling inductance with a more simple and efficient method.

According to an exemplary embodiment of the present invention, there is provided a multilayer type inductor, including: a ceramic body formed by multilayering a plurality of ceramic sheets; internal electrodes multilayered, having the ceramic sheet disposed therebetween; a dummy pattern disposed on any one of upper and lower surfaces of the ceramic body; and external terminals disposed at both ends of the ceramic body.

The dummy pattern may be disposed at a position through which a magnetic flux generated from the internal electrode passes, in the upper surface or lower surface of the ceramic body.

The dummy pattern may be disposed at a portion adjacent to a point vertically facing the internal electrode.

An area of the dummy pattern may be changed depending on an inductance value to be controlled.

The dummy pattern may be formed in any one of a quadrangle, a triangle, and a circle.

The dummy pattern may be formed in plural.

As a material of the dummy pattern, copper (Cu) or silver (Ag) may be used.

According to another exemplary embodiment of the present invention, there is provided a multilayer type inductor including: a ceramic body formed by multilayering a plurality of ceramic sheets; a plurality of internal electrodes multilayered, having the ceramic sheet disposed therebetween; and external terminals disposed at both ends of the ceramic body, wherein the ceramic body includes a capacitance part in which the internal electrode is embedded and an upper margin part and a lower margin part which are formed by multilayering only the ceramic sheet and disposed at upper and lower portions of the capacitance part, and a dummy pattern is embedded at any one of the upper and lower margin parts.

The dummy pattern may be formed in plural on the same layer. The dummy pattern may be formed in plural and the plurality of dummy patterns may be disposed on different layers.

### BRIEF DESCRIPTION OF THE DRAWINGS

FIG. 1 is an appearance perspective view of a multilayer type inductor according to an exemplary embodiment of the present invention.

FIG. 2 is a cross-sectional view taken along the line I-I′ of FIG. 1.

FIGS. 3A-C is a plan view illustrating a change in an area of a dummy pattern according to the exemplary embodiment of the present invention.

FIG. 4 is a graph illustrating a rate of change in inductance values depending on a length of the dummy pattern according to the exemplary embodiment of the present invention.

FIG. 5 is a cross-sectional view of a multilayer type inductor according to another exemplary embodiment of the present invention.

FIG. 6 is a cross-sectional view of a multilayer type inductor according to another exemplary embodiment of the present invention.

FIG. 7 is a graph illustrating a rate of change in inductance values depending on the number of layers of the multilayered internal electrodes.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. Further, the word “constituents”, “steps”, “operations”, and/or “elements” mentioned herein will be understood to imply the inclusion of stated constituents, steps, operations and/or elements but not the exclusion of any other constituents, steps, operations and/or elements.

Hereinafter, a configuration and an action effect of the present invention will be described in more detail with reference to the accompanying drawings.

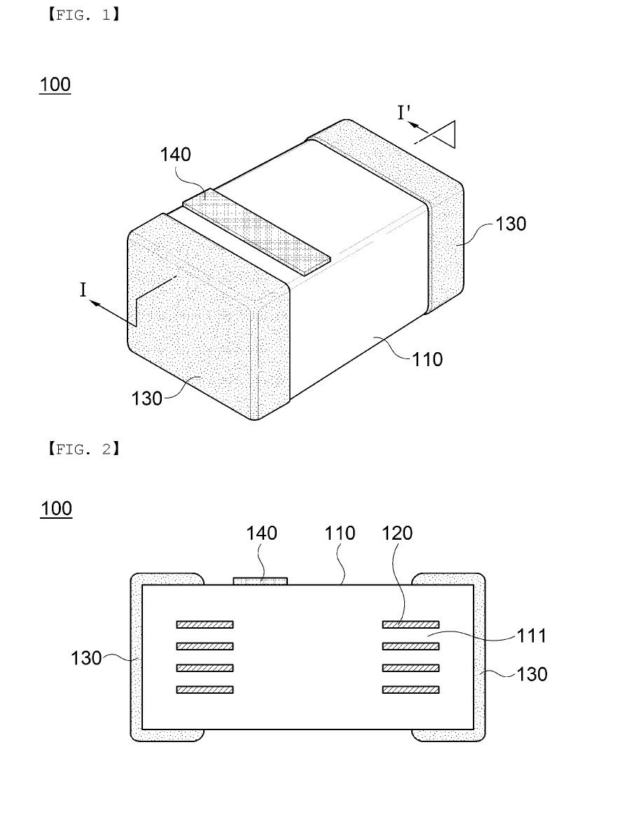

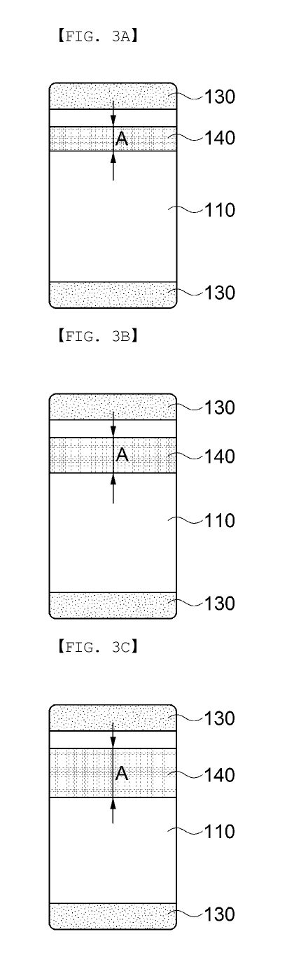

FIG. 1 is an appearance perspective view of a multilayer type inductor according to an exemplary embodiment of the present invention and FIG. 2 is a cross-sectional view of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention. For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscure.

Referring to FIGS. 1 and 2, a multilayer type inductor 100 according to the exemplary embodiment of the present invention may be basically configured to include a ceramic body 110 in which internal electrodes 120 are embedded and a pair of external terminals 130 disposed at both ends of the ceramic body 110.

The ceramic body 110 is a hexahedron which is made of a ceramic material and manufactured at a size of, for example, 2012 (2.0 mm×1.2 mm×1.2 mm), 1005 (1.0 mm×0.5 mm×0.5 mm), 0603 (0.6 mm×0.3 mm×0.3 mm), 0402 (0.4 mm×0.2 mm×0.2 mm) and may be completed by multilayering a plurality of ceramic sheets 111 in a thickness direction and pressing and sintering the plurality of ceramic sheets 111, in which the ceramic sheet 111 is made of Fe—Ni—Zn oxides, Fe—Ni—Zn—Cu oxides, or metal-based ferrite, such as Fe, Ni, and Fe—Ni (Permalloy), as main components. Therefore, the adjacent ceramic sheets 111 are integrated enough not to differentiate a boundary therebetween and thus the ceramic body 110 may be formed.

The internal electrodes 120, which are a metal wiring having a coil pattern which is made of any one selected from Ni, Al, Fe, Cu, Ti, Cr, Au, Ag, Pd, and Pt having excellent electrical conductivity, may be multilayered having at least one ceramic sheet 111 therebetween.

The internal electrode 120 may be formed by printing a metal paste on a ceramic sheet 111 depending on a coil pattern by using a screen printing method and the internal electrodes of each layer have a coil structure in which an interlayer is electrically connected via a conductive via (not illustrated) penetrating through the ceramic sheet 111 between the internal electrodes to be circulated in a spiral shape.

Among the internal electrodes 120, the internal electrodes 120 multilayered on a top layer and a bottom layer are each connected to external terminals 130 to receive an external voltage. That is, an end of the internal electrode 120 multilayered on the top layer extends to one side of the ceramic body 110 to be connected to any one of the pair of external terminals 130 and an end of the internal electrode 120 multilayered on the bottom layer extends to the other side of the ceramic body 110 to be connected to the other external terminal 130.

As such, the internal electrodes 120 electrically connected to the pair of external terminals 130 which is input and output terminals receives a voltage from the outside therethrough and thus when a current flows in the internal electrodes 120 having the coil structure, a magnetic flux having an open magnetic circuit structure to pass through the outside of the ceramic body 110 is formed.

In this case, according to the exemplary embodiment of the present invention, a dummy pattern 140 which blocks a portion of the so formed magnetic flux is disposed on at least one of the upper and lower surfaces of the ceramic body 110 to finely control inductance values. That is, according to the exemplary embodiment of the present invention, the inductance values may be controlled by using the reduction in inductance values due to the blocking of the flow of magnetic flux by the dummy pattern 140.

Herein, the upper and lower surfaces of the ceramic body 110, which are a surface facing a multilayered surface of the ceramic sheet 111, become a surface through which a magnetic flux generated from the internal electrode 120 passes and the dummy pattern 140 blocks a magnetic flux passing through the upper surface of the lower surface of the ceramic body 110.

Therefore, the dummy pattern 140 is disposed at a position at which the magnetic flux generated from the internal electrode passes, among the upper surface or the lower surface of the ceramic body 110 and in order to more effectively block the magnetic flux by forming the magnetic flux around the internal electrode 120, is disposed at a portion adjacent to a point vertically facing the internal electrode 120.

As such, according to the exemplary embodiment of the present invention, the dummy pattern 140 is used to block the flow of magnetic flux, and therefore as a material forming the dummy pattern 140, any material which may block the flow of magnetic flux is used without being particularly limited. However, for easiness of the process, the same material as the internal electrode 120, for example, copper (Cu) or silver (Ag) may be used.

Meanwhile, the amount of magnetic flux blocked by the dummy pattern 140 is proportional to an area of the dummy pattern 140, and thus the area of the dummy pattern 140 may be changed depending on the inductance values to be controlled as illustrated in FIGS. 3A to 3C.

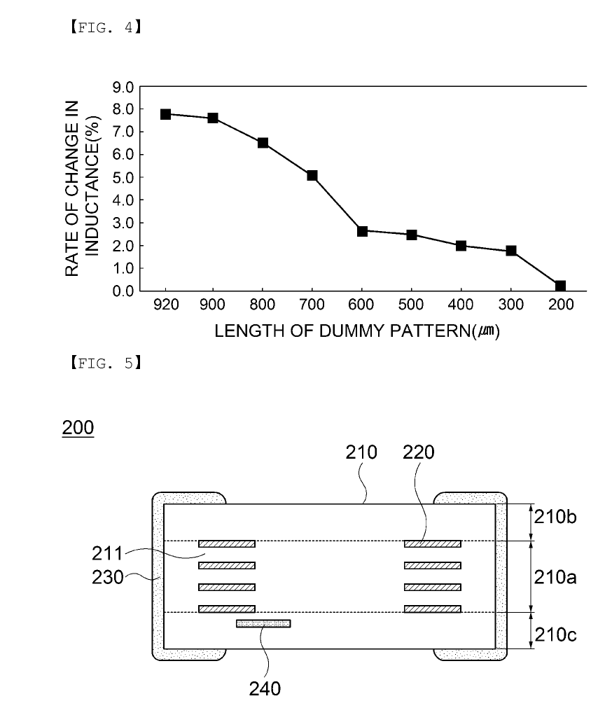

FIG. 4 is a graph illustrating a rate of change in the inductance values depending on a length (FIG. 3A) of the dummy pattern 140 and illustrates a result obtained by confirming the change in inductance values by changing a length A of the dummy pattern 140, that is, the area thereof by using the inductor element having the same turn number and a size of 1005 (1.0 mm×0.5 mm×0.5 mm).

It may be appreciated from FIG. 4 that as the area of the dummy pattern 140 is increased, the inductance value is reduced, in detail, the inductance value is changed from a minimum of 0.3% to a maximum of 7.8%. That is, as the area of the dummy pattern 140 is increased, the amount of magnetic flux blocked by the dummy pattern 140 is increased and thus the inductance value is reduced.

Therefore, according to the exemplary embodiment of the present invention, the internal electrodes 120 are sufficiently multilayered to exceed the required inductance value and then the area of the dummy pattern 140 is slowly increased to possibly meet the required inductance value, such that it is possible to control the number of layers of the internal electrodes or the internal area of the coil, thereby more finely controlling the inductance values as compared with the method according to the related art which controls the inductance value.

As described above, in the multilayer type inductor 100 according to the exemplary embodiment of the present invention, the inductance value is controlled depending on the area of the dummy pattern 140, such that as various modification examples of the dummy pattern 140, the shape of the dummy pattern 140 may be variously manufactured. For example, the dummy pattern 140 may be manufactured to have any one of a quadrangle, a triangle, and a circle.

Further, the dummy pattern 140 may be configured in plural. In this case, a total area of the dummy pattern 140 configured in plural may be appropriately set depending on the inductance value to be controlled with reference to FIG. 4.

Hereinafter, the multilayer type inductor according to another exemplary embodiment of the present invention will be described.

FIG. 5 is a cross-sectional view illustrating a multilayer type inductor according to another exemplary embodiment of the present invention and a multilayer type inductor 200 according to another exemplary embodiment of the present invention may include a ceramic body 210, an internal electrode 220, and an external terminal 230 having the same function and structure as the multilayer type inductor 100 of FIG. 2. Further, the ceramic body 210 may include a capacitance part 210a in which the internal electrode 220 is embedded and an upper margin part 210b and a lower margin part 210c which are disposed on upper and lower portions of the capacitance part 210a.

The upper margin part 210b and the lower margin part 210c are formed only by multilayering the ceramic sheet 211 and the multilayer type inductor 200 according to another exemplary embodiment of the present invention has a structure in which a dummy pattern 240 is embedded in any one of the upper margin part 210b and the lower margin part 210c.

That is, the dummy pattern 240 may be interposed between the ceramic sheets 211 configuring the upper margin part 210b or the lower margin part 210c and is disposed at a point blocking a part of the magnetic flux generated from the internal electrode 220 to serve to block the magnetic flux. Further, in order to more effectively block the magnetic flux, the dummy pattern 240 may be disposed at a portion adjacent to a point vertically facing the internal electrode 220.

The amount of magnetic flux blocked by the dummy pattern 240 is determined by the area of the dummy pattern 240, such that the dummy pattern 240 may be multilayered at any height in the upper margin part 210b or the lower margin part 210c and the shape thereof may be variously manufactured in various shapes, such as a quadrangle, a triangle, and a circle.

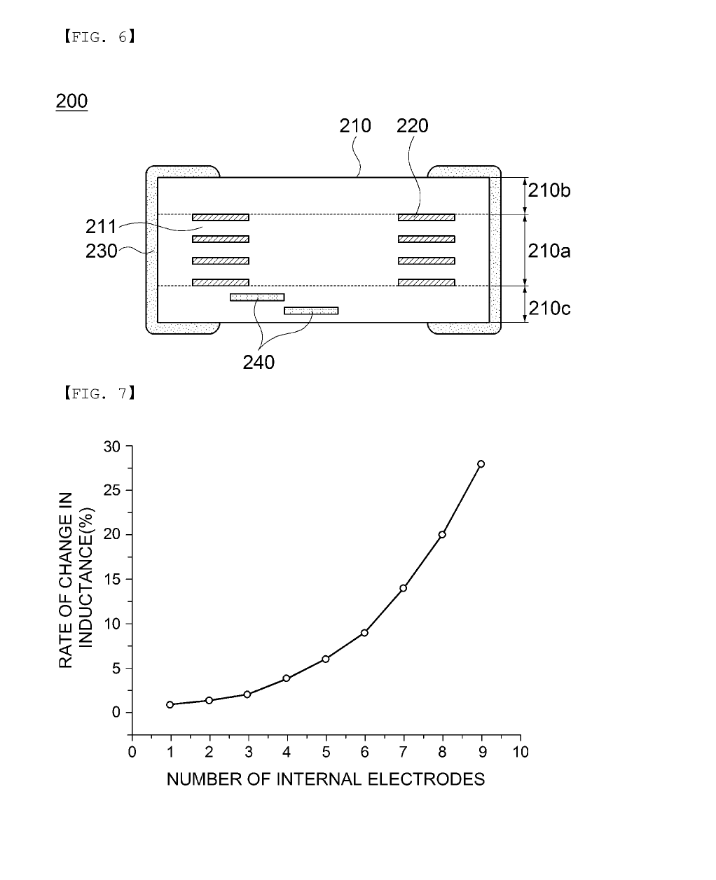

Further, the dummy pattern 240 may be formed in plural. In this case, all the plurality of dummy patterns 240 are disposed on the same layer, but unlike this, as illustrated in FIG. 6, may be disposed on different layers.

With the multilayer type inductor according to the exemplary embodiments of the present invention, as compared with the related art, the production cost may be more saved and the yield may be largely improved, by controlling the inductance values to the desired values with the more simple structure.

Further, since the inductance values to be controlled is determined depending on the area of the dummy pattern, the inductance values may be more finely controlled, such that the inductance values which may not implemented by the difference of the number of layers of the internal electrodes and the internal area of the coil according to the related art may be implemented.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A multilayer type inductor, comprising:
a ceramic body formed by multilayering a plurality of ceramic sheets;
internal electrodes multilayered, having the ceramic sheet disposed therebetween;
a dummy pattern disposed on any one of upper and lower surfaces of the ceramic body; and
external terminals disposed at both ends of the ceramic body.

2. The multilayer type inductor according to claim 1, wherein the dummy pattern is disposed at a position through which a magnetic flux generated from the internal electrode passes, in the upper surface or lower surface of the ceramic body.

3. The multilayer type inductor according to claim 1, wherein the dummy pattern is disposed at a portion adjacent to a point vertically facing the internal electrode.

4. The multilayer type inductor according to claim 1, wherein an area of the dummy pattern is changed depending on an inductance value to be controlled.

5. The multilayer type inductor according to claim 1, wherein the dummy pattern is formed in any one of a quadrangle, a triangle, and a circle.

6. The multilayer type inductor according to claim 1, wherein the dummy pattern is formed in plural.

7. The multilayer type inductor according to claim 1, wherein as a material of the dummy pattern, copper (Cu) or silver (Ag) is used.

8. A multilayer type inductor, comprising:
a ceramic body formed by multilayering a plurality of ceramic sheets;
a plurality of internal electrodes multilayered, having the ceramic sheet disposed therebetween; and
external terminals disposed at both ends of the ceramic body,
wherein the ceramic body includes a capacitance part in which the internal electrode is embedded and an upper margin part and a lower margin part which are formed by multilayering only the ceramic sheet and disposed at upper and lower portions of the capacitance part, and a dummy pattern is embedded at any one of the upper and lower margin parts.

9. The multilayer type inductor according to claim 8, wherein the dummy pattern is formed in plural on the same layer.

10. The multilayer type inductor according to claim 8, wherein the dummy pattern is formed in plural and the plurality of dummy patterns are disposed on different layers.
